(19) United States
(12) Patent Application Publication
(10) Pub. No.: US 2007/0036929 A1
(43) Pub. Date: Feb. 15, 2007

(54) Thin film applique

(75) Inventors: Richard W. Baird, Covington, WA (US); Glenn R. Dalby, Shoreline, WA (US); William J. Postl, Mount Vernon, WA (US)

Correspondence Address: ROBERT R. RICHARDSON, P.S., P. O. BOX 2677, SILVERDALE, WA, 98383-2677, US

(73) Assignee: The Boeing Company

(21) Appl. No.: 11/203,869

(22) Filed: Aug. 9, 2005

(51) Int. Cl. B32B 33/00; B32B 3/00

(52) U.S. Cl. 428/40.1; 428/203; 428/913.3

(57) ABSTRACT

An exemplary thin film appliqué includes a polymer film having first and second sides. A pattern layer has first and second sides, and the first side of the polymer film and the first side of the pattern layer are positioned adjacent each other. A pressure-sensitive adhesive underlies one of the second side of the pattern layer and the second side of the polymer film. A clearcoat covers one of the second side of the polymer film and the second side of the pattern layer that is not overlying the pressure-sensitive adhesive, and thickness of the clearcoat is equalized toward a combined thickness of the polymer film, the pattern layer, and the pressure-sensitive adhesive. The polymer film, the pattern layer, and the pressure-sensitive adhesive exhibit chemical affinity for each other.

### BACKGROUND

Decal systems or appliqués are currently used for exterior decoration of vehicles, including aircraft and land vehicles such as automobiles, trucks, and motorcycles. Because land vehicles typically operate in relatively benign environments (compared to aircraft operating environments), decal systems for land vehicles may be as simple as a sticker covered with paint. However, such a simple decal system for land vehicles would not be able to withstand erosion due to wind and/or rain that can occur in aircraft operating environments.

A typical decal system used for aircraft includes a pigmented polymer film/pressure-sensitive adhesive (PSA) laminate. The laminate is provided to a printer, who prints graphics on top of the laminate and applies a topcoat on top of the decal system. The decal system is applied to an aircraft skin and edge sealer, such as a border of clear paint, is brushed onto edges of the decal system. Another typical decal system consists of a clear polymer film which is provided to a printer, who prints graphics on the bottom side of the film, then applies the pressure-sensitive adhesive. This system is then applied to the aircraft skin and edge sealer is applied around its borders in similar fashion.

Conventional decal systems and appliqués for aircraft application typically have a thickness of around 5/1000 inch (5 mils) or so. The sharp edge creates a step of around 5 mils thickness that may be exposed and subject to wind- and rain-erosion at aircraft cruise speeds. The thicker the edge, the harder it is to cover the edge step, thereby resulting in exposure of part of the edge step. As a result, conventional decal systems and appliqués that are applied to an aircraft, especially in the nose section and on leading edges of flight control surfaces, may be subject to delamination, peeling, or complete removal.

Delamination and peeling may shorten the service life of the decal system or appliqué. Moreover, if a decal is used for mandatory markings on an aircraft and is removed during flight (such as by wind- or rain-erosion), then Federal Aviation Administration (FAA) rules mandate that the aircraft be taken out of service. The mandatory markings must be replaced to return the aircraft to service. When the aircraft is a commercial aircraft, it is desirable to return the aircraft to revenue service as soon as possible.

One approach to addressing the above problems of conventional decal systems and appliqués on aircraft is by use of stenciling. Stenciling, though, also has shortcomings. For example, there is a limit in how small a font can be used. Further, stenciling is time- and labor-intensive. Finally, characters must be exact, thereby increasing time consumption for proofreading and correcting errors.

The foregoing examples of related art and limitations associated therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods which are meant to be exemplary and illustrative, not limiting in scope. In various embodiments, one or more of the problems described above in the Background have been reduced or eliminated, while other embodiments are directed to other improvements.

Embodiments provide a thin film appliqué. The exemplary embodiments of thin film appliqués described herein advantageously may be more resistant to wind- or rain-erosion than conventional appliqués when used on aircraft, and may thereby reduce frequency of removing an aircraft from service for replacement of mandatory markings.

An exemplary appliqué includes a polymer film having first and second sides. A pattern layer has first and second sides, and the first side of the polymer film and the first side of the pattern layer are positioned adjacent each other. A pressure-sensitive adhesive underlies one of the second side of the pattern layer and the second side of the polymer film. A clearcoat covers one of the second side of the polymer film and the second side of the pattern layer that is not overlying the pressure-sensitive adhesive, and thickness of the clearcoat is equalized toward a combined thickness of the polymer film, the pattern layer, and the pressure-sensitive adhesive.

According to aspects, the polymer film, the pattern layer, and the pressure-sensitive adhesive exhibit chemical affinity for each other. The polymer film may include polyvinyl fluoride, polyvinyl chloride, polyester, a urethane film or an epoxy film. Also, the pattern layer may include an ink layer.

According to further aspects, the clearcoat may be applied after the pressure-sensitive adhesive is adhered to a substrate.

In addition to the exemplary embodiments and aspects described above, further embodiments and aspects will become apparent by reference to the drawings and by study of the following detailed description.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIGS. 1A and 1B are side views of embodiments of a thin film appliqué applied to a substrate;

FIGS. 2A and 2B are side views of the thin film appliqués of FIGS. 1A and 1B, respectively, before application to the substrate; and

FIG. 3 is an illustration of the exemplary appliqués of FIGS. 1A and/or 1B applied to an aircraft.

### DETAILED DESCRIPTION

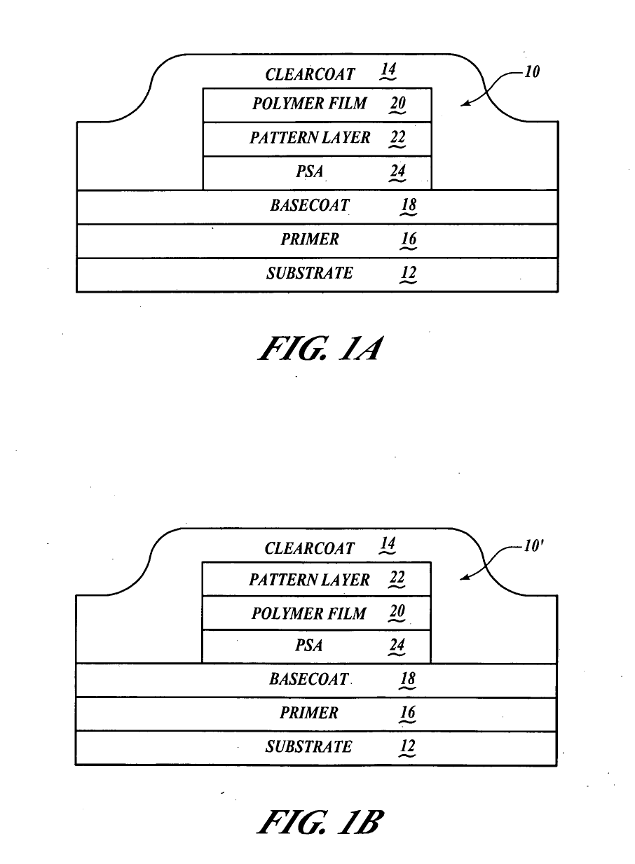

Referring to FIGS. 1A and 1B and by way of overview, an appliqué 10 (FIG. 1A) or an appliqué 10′ (FIG. 1B) according to exemplary embodiments is applied to a substrate 12, such as without limitation an aircraft skin. The appliqué 10 (FIG. 1A) and the appliqué 10′ (FIG. 1B) suitably are covered completely by a clearcoat 14. Advantageously and as a result, the appliqué 10 (FIG. 1A) and the appliqué 10′ (FIG. 1B) may be more resistant to wind- or rain-erosion than conventional appliqués when used on aircraft, and may thereby reduce frequency of removing an aircraft from service for replacement of mandatory markings. Details regarding exemplary embodiments will be set forth below.

Still referring to FIGS. 1A and 1B and given by way of non-limiting example, the substrate 12 may be an aircraft skin, such as without limitation a fuselage skin, a vertical stabilizer skin, an engine nacelle, or the like. While embodiments of the thin film appliqué described herein are well-suited to aircraft applications because of increased resistance to wind- or rain-erosion than conventional appliqués, the exemplary thin film appliqués described herein may be used on any substrate as desired for a particular application. For example, the appliqué 10 (FIG. 1A) and the appliqué 10′ (FIG. 1B) may be applied to substrates such as land vehicle body panels, maritime vessel hulls and superstructures, spacecraft skins, and the like. In certain applications, the substrate 12 may be coated with a primer 16, such as without limitation an anodize coating, a chromate conversion coating like Alodine, or the like, and a basecoat 18 of paint, as desired.

The appliqué 10 (FIG. 1A) and the appliqué 10′ (FIG. 1B) each includes a polymer film 20, a pattern layer 22, and a pressure sensitive adhesive (PSA) 24. The total combined thickness of the polymer film 20, the pattern layer 22, and the PSA 24 is on the order of around 0.0017-0.0023 inches (1.7-2.3 mils). The thickness of the clearcoat 14 on the top layer (either the polymer film 20 or the pattern layer 22) is equalized toward the combined thickness of the polymer film 20, the pattern layer 22, and the PSA 24 and therefore is also on the order of around 1.7-2.3 mils. Because of the low profile of the appliqué 10 (FIG. 1A) and the appliqué 10′ (FIG. 1B), the covering of the appliqué 10 (FIG. 1A) and the appliqué 10′ (FIG. 1B) by the clearcoat 14, and the selection of materials for the components of the appliqué 10 (FIG. 1A) and the appliqué 10′ (FIG. 1B), the appliqué 10 (FIG. 1A) and the appliqué 10′ (FIG. 1B) are able to withstand the harsh conditions and environment presented by an aircraft in flight. Each of the components of the appliqué 10 (FIG. 1A) and the appliqué 10′ (FIG. 1B) will be discussed in turn below. In addition, certain combinations of exemplary materials for the components of the appliqué 10 (FIG. 1A) and the appliqué 10′ (FIG. 1B) will be highlighted below.

The polymer film 20 is a thin film that is made of a suitable material that can withstand temperatures and high-speed wind and rain impingement associated with flight conditions. The polymer film 20 suitably has a thickness in a range between around 0.5 mil and around 1.0 mil. The polymer film 20 preferably has other desirable characteristics. For example, the polymer film 20 preferably is thermally resistant to temperatures encountered during flight conditions, such as temperatures in a range between around −65 degrees Fahrenheit to around +160 degrees Fahrenheit. As a further example, the polymer film 20 preferably is resistant to fluids, such as phosphate ester-based hydraulic fluid (e.g., SKYDROL®). The polymer film 20 preferably has surface characteristics that promote strong adherence of the clearcoat 14, the pattern layer 22, and the PSA 24 to the polymer film 20. Finally, the polymer film 20 preferably is impact-resistant and flexible, with a flexibility on the order of around 5-10 percent extension.

The polymer film 20 may be embodied in any suitable polymeric film as desired. For example, the polymer film 20 may be a urethane film, an acrylic film, or an epoxy film. In addition, the polymer film 20 may be a vinyl, such as polyvinyl chloride (PVC) or polyvinyl fluoride like TEDLAR®, available from DuPont. Further, the polymer film 20 may be a polyester such as MYLAR®, available from DuPont. If desired, a binder additive may be included with the polymer film 20 to improve cohesive strength.

The polymer film 20 may be clear or pigmented, as desired for a particular application. When the polymer film 20 is clear, the pattern layer 22 may provided between the polymer film 20 and the PSA 24 (as shown in FIG. 1A). Alternately, when the polymer film 20 is clear, the pattern layer 22 may be provided on top of the polymer film 20 (as shown in FIG. 1B). When the polymer film 20 is pigmented, the pattern layer 22 may likewise be provided on top of the polymer film 20 (as shown in FIG. 1B). The polymer film 20 may be impregnated with a material, such as without limitation TiO₂, that causes the polymer film 20 to act as a reflective background that brings out the color of the pattern layer 22.

The pattern layer 22 suitably is a layer of ink. The pattern layer has a thickness on the order of around 0.2-0.3 mils. The ink desirably has a fairly high opacity, such that the pattern layer 22 is fully opaque when the pattern layer 22 has a thickness on the order of around 0.2-0.3 mils. The surface tension of the ink should be compatible with the surface tension of the polymer film 20. In the embodiment shown in FIG. 1A, the surface tension of the ink should also be compatible with the surface tension of the PSA 24. In the embodiments shown in FIGS. 1A and 1B, the surface tension of the ink should also be compatible with the surface tension of the clearcoat 14. The ink used for the pattern layer 22 may be any acceptable commercial-off-the-shelf ink. Non-limiting examples of acceptable inks include pigmented acrylic ink, pigmented fast-dry acrylic ink, urethane ink with pigment, epoxy ink, a urethane enamel coating such as Desothane®, and the like. If desired, an adhesion promoter may be included with the pattern layer 22.

The PSA 24 suitably is any acceptable, commercially-available, acrylic PSA. If desired, the PSA 24 may be ultraviolet (UV) resistant. The PSA 24 suitably has a thickness on the order of around 1 mil. The PSA 24 desirably has a surface tension that is compatible with the surface tension of the clear coat 14. The PSA 24 preferably does not contain volatile or mobile components that may tend to migrate to the outer surface of the appliqué 10 or to an interface within the appliqué 10, where they may promote delamination of the appliqué 10 or impede wetting of the appliqué 10 by the clearcoat 14. Also, the PSA 24 desirably is resistant to fluids, such as water, hydraulic fluids, SKYDROL®, and the like, and will adhere strongly to the basecoat 18 and overlying polymer film 20 and pattern layer 22.

Unless indicated otherwise, all further references in the Detailed Description to the appliqué 10 are intended to also include the appliqué 10′ and are not intended to refer only to the appliqué 10 to the exclusion of the appliqué 10′. The clearcoat 14 provides a means for encapsulating the appliqué 10. As such, the clearcoat 14 suitably provides UV protection, has a smooth finish, provides high gloss on the order of around 80-90 gloss units, and provides resistance to impacts and to fluids such as water, hydraulic fluid, SKYDROL®, and the like. To that end, the clearcoat 14 contributes to resistance of the appliqué 10 to wind- and rain-erosion. In one embodiment, the clearcoat 14 is applied over the appliqué 10 after the appliqué 10 is applied to the substrate 12. Given by way of non-limiting example, the clearcoat 14 may be sprayed as a layer that covers the entire appliqué 10. In addition, if desired, the clearcoat 14 may be painted around edges of the appliqué 10. Non-limiting examples of acceptable clearcoat include polyurethane coatings such as Desothane HS® BAC 900 (CA8000/B900A or CA8000/B900B) from PRC/DeSoto or Eclipse® BAC 900 clearcoat from Akzo-Nobel, and the like.

The polymer film 20, the pattern layer 22, and the PSA 24 advantageously are selected to adhere strongly to each other. To that end, certain key chemical parameters of the polymer film 20, the pattern layer 22, and the PSA 24, such as surface tension and the polarizability of chemical species (moieties) on the surfaces thereof, are similar in value such that the polymer film 20, the pattern layer 22, and the PSA 24 all have a high chemical affinity for each other. For example, the surface tension of the polymer film 20, the pattern layer 22, and the PSA 24 suitably are all within around +/−5 dyn/cm of each other. Furthermore, it is desirable that the surface tension of the polymer film 20, the pattern layer 22, and the PSA are all compatible with the surface tension of the clearcoat 14. This is because the polymer film 20, the pattern layer 22, and the PSA 24 are all in contact at their edges with the clearcoat 14. Further, in the embodiment shown in FIG. 1A, the top of the polymer film 20 is covered by the clearcoat 14 and, in the embodiment shown in FIG. 1B, the top of the pattern layer 22 is covered by the clearcoat 14.

While various materials have been discussed for the components of the appliqué 10 (that is, the polymer film 20, the pattern layer 22, and the PSA 24), certain combinations of components of the appliqué 10 may be better suited for use with each other than other combinations. Table 1 below shows, by way of non-limiting examples, combinations of components of the appliqué 10 that are well suited to each other.

TABLE 1

| Polymer Film 20 | Pattern Layer 22 | PSA 24 |
|---|---|---|
| Urethane | Pigmented fast-dry acrylic | Acrylic |
| Urethane | Urethane with pigment | Acrylic |
| Urethane | Desothane | Acrylic |
| Urethane | Epoxy | Acrylic |
| Acrylic | Pigmented fast-dry acrylic | Acrylic |
| Epoxy | Epoxy | Acrylic |

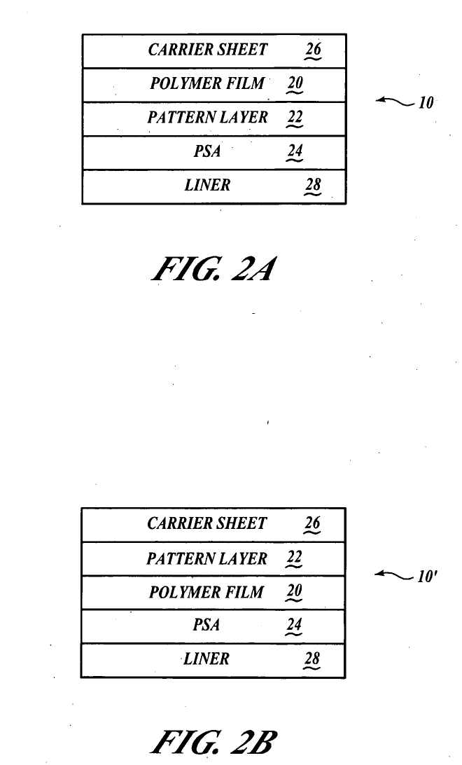

Referring now to FIGS. 2A and 2B, before the appliqué 10 or the appliqué 10′ is applied to the substrate 12, (FIGS. 1A and 1B), the appliqués 10 and 10′ are covered by a carrier sheet 26 and a liner 28. The carrier sheet 26 and the liner 28 protect the appliqués 10 and 10′ before application, and provide for ease of handling and ease of application. In the embodiment shown in FIG. 2A, the carrier sheet 26 covers the polymer film 20. In the embodiment shown in FIG. 2B, the carrier sheet 26 covers the pattern layer 22. In certain embodiments (not shown), the carrier sheet 26 may be omitted if deemed to be not needed to assist in application of the appliqués 10 and 10′. In the embodiments shown in both FIGS. 2A and 2B, the liner 28 underlies the PSA 24. In addition to assisting in application of the appliqués 10 and 10′ the liner 28 protects the PSA 24 from damage by unintentional contact with other surfaces. The carrier sheet 26 adheres to the polymer film 20 (FIG. 2A) or to the pattern layer 22 (FIG. 2B) with an adhesion strength that is stronger than the adhesion strength with which the liner 28 adheres to the PSA 24. However, both of these adhesion strengths are less than the adhesion strength between the PSA 24 and the substrate 12 (FIGS. 1A and 1B).

Referring now to FIGS. 1A, 1B, 2A, and 2B, this ordering of adhesion strengths ensures that the liner 28 can come off the PSA 24 when preparing to apply the appliqué 10 or 10′ to the substrate 12 while permitting the carrier sheet 26 to still adhere to the polymer film 20 or the pattern layer 22. Once the liner 28 has been removed and the PSA 24 adheres to the substrate 12, the carrier sheet 26 can be removed from the polymer film 20 or the pattern layer 22.

At this point, the appliqué 10 or 10′ is applied to the substrate 12 but the polymer film 20 or the pattern layer 22 is not yet covered by the clearcoat 14. If desired, the polymer film 20 or the pattern layer 22 may be rinsed and wiped down with a cleaning agent, such as without limitation isopropyl alcohol, to remove any contamination before the clearcoat 14 is applied. With the appliqué 10 or 10′ thus applied to the substrate 12, the clearcoat 14 can be applied as desired (such as by spraying) to completely cover the polymer film 20 or the pattern layer 22.

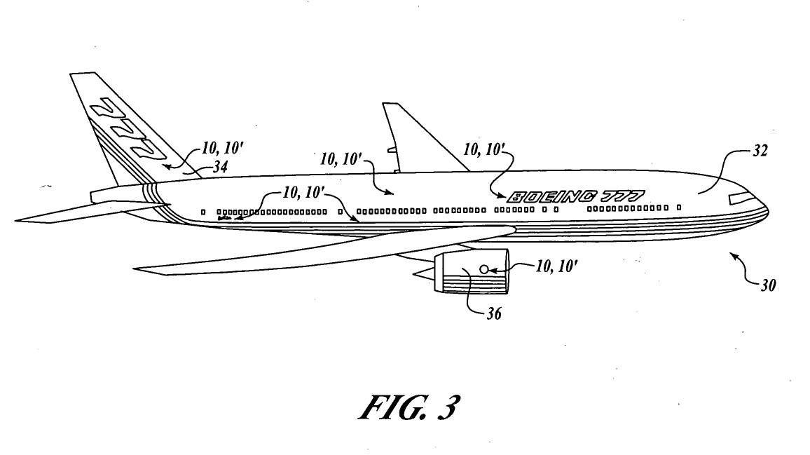

Referring now to FIGS. 1A, 1B, and 3, the appliqués 10 and 10′ are well suited for use on skin of an aircraft 30. Because of the materials selected for the polymer film 20, the pattern layer 22, and the PSA 24, and because of the thin overall thickness of the appliqués 10 and 10′ that is on the order of around 1-2 mils, and because the appliqués 10 and 10′ are completely covered by the clearcoat 14, the appliqués 10 and 10′ are more resistant to wind- and rain-erosion than are conventional appliqués.

Given by way of non-limiting example, the appliqués 10 and/or 10′ may be applied to skin of a fuselage 32 of the aircraft 30. The aircraft 30 may be any type of known aircraft that includes an airframe and skin. In this non-limiting example, the pattern layers 22 may give effect to an image such as airline livery (not shown), to solid colors (such as the solid white color or the dark stripes shown on the fuselage 32, to mandatory markings such as an aircraft tail number, and to stylized text such as BOEING 777 shown on the fuselage 32 and 777 shown on skin of a vertical stabilizer 34. As another non-limiting example, the pattern layers 22 of the appliqué 10 and/or 10′ that are applied to an exterior skin of an engine nacelle 36 may give effect to an image of an jet engine manufacturer.

While a number of exemplary embodiments and aspects have been illustrated and discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

What is claimed is:

1. An appliqué comprising:
a polymer film having first and second sides;
a pattern layer having first and second sides, the first side of the polymer film and the first side of the pattern layer being positioned adjacent each other;
a pressure-sensitive adhesive underlying one of the second side of the pattern layer and the second side of the polymer film; and
a clearcoat covering one of the second side of the polymer film and the second side of the pattern layer that is not overlying the pressure-sensitive adhesive, wherein thickness of the clearcoat is equalized toward a combined thickness of the polymer film, the pattern layer, and the pressure-sensitive adhesive.

2. The appliqué of claim 1, wherein the polymer film includes one of polyvinyl fluoride, polyvinyl chloride, polyester, a urethane film, an acrylic film, and an epoxy film.

3. The appliqué of claim 1, wherein the pattern layer includes one of a urethane layer, an acrylic layer, and an epoxy layer.

4. The appliqué of claim 1, wherein the pattern layer includes an ink layer.

5. The appliqué of claim 1, wherein the clearcoat includes a polyurethane coat.

6. The appliqué of claim 1, wherein the pressure-sensitive adhesive includes an acrylic adhesive.

7. The appliqué of claim 1, wherein:
the polymer film has a thickness in a range between around 0.5 mil and around 1.0 mil;
the pattern layer has a thickness in a range between around 0.2 mil and around 0.3 mil; and
the pressure-sensitive adhesive has a thickness on the order of around 1 mil.

8. The appliqué of claim 1, wherein the polymer film, the pattern layer, and the pressure-sensitive adhesive exhibit chemical affinity for each other.

9. The appliqué of claim 8, wherein the polymer film, the pattern layer, and the pressure-sensitive adhesive have values of surface tension that are within around +/−5 dyn/cm of each other.

10. An appliqué comprising:
a polymer film having first and second sides;
a pattern layer having first and second sides, the first side of the polymer film and the first side of the pattern layer being positioned adjacent each other; and
a pressure-sensitive adhesive underlying one of the second side of the pattern layer and the second side of the polymer film, wherein the polymer film, the pattern layer, and the pressure-sensitive adhesive exhibit chemical affinity for each other.

11. The appliqué of claim 10, wherein the polymer film, the pattern layer, and the pressure-sensitive adhesive have values of surface tension that are within around +/−5 dyn/cm of each other.

12. The appliqué of claim 10, wherein:
the polymer film has a thickness in a range between around 0.5 mil and around 1.0 mil;
the pattern layer has a thickness in a range between around 0.2 mil and around 0.3 mil; and
the pressure-sensitive adhesive has a thickness on the order of around 1 mil.

13. The appliqué of claim 10, further comprising:
a removable carrier sheet overlying one of the second side of the polymer film and the second side of the pattern layer; and
a removable liner underlying the pressure-sensitive adhesive.

14. The appliqué of claim 10, wherein:
the liner is adhered to the pressure-sensitive adhesive with a first adhesive strength;
the carrier sheet is adhered to one of the second side of the polymer film and the second side of the pattern layer with a second adhesive strength that is greater than the first adhesive strength; and
the pressure-sensitive adhesive is configured to adhere to a substrate with a third adhesive strength that is greater than the second adhesive strength.

15. The appliqué of claim 10, wherein the polymer film includes one of polyvinyl fluoride, polyvinyl chloride, polyester, a urethane film, an acrylic film, and an epoxy film.

16. The appliqué of claim 10, wherein the pattern layer includes one of a urethane layer, an acrylic layer, and an epoxy layer.

17. The appliqué of claim 10, wherein the pattern layer includes an ink layer.

18. The appliqué of claim 10, wherein the pressure-sensitive adhesive includes an acrylic adhesive.

19. An aircraft comprising:
an airframe covered by skin; and
at least one appliqué applied to the skin, the appliqué including:
a polymer film having first and second sides;
a pattern layer having first and second sides, the first side of the polymer film and the first side of the pattern layer being positioned adjacent each other;
a pressure-sensitive adhesive underlying one of the second side of the pattern layer and the second side of the polymer film; and
a clearcoat covering one of the second side of the polymer film and the second side of the pattern layer that is not overlying the pressure-sensitive adhesive, wherein thickness of the clearcoat is equalized toward a combined thickness of the polymer film, the pattern layer, and the pressure-sensitive adhesive.

20. The aircraft of claim 19, wherein the polymer film includes one of polyvinyl fluoride, polyvinyl chloride, polyester, a urethane film, an acrylic film, and an epoxy film.

21. The aircraft of claim 19, wherein the pattern layer includes one of a urethane layer, an acrylic layer, and an epoxy layer.

22. The aircraft of claim 19, wherein the pattern layer includes an ink layer.

23. The aircraft of claim 19, wherein the clearcoat includes a polyurethane coat.

24. The aircraft of claim 19, wherein the pressure-sensitive adhesive includes an acrylic adhesive.

25. The aircraft of claim 19, wherein:
the polymer film has a thickness in a range between around 0.5 mil and around 1.0 mil;
the pattern layer has a thickness in a range between around 0.2 mil and around 0.3 mil; and
the pressure-sensitive adhesive has a thickness on the order of around 1 mil.

26. The aircraft of claim 19, wherein the polymer film, the pattern layer, and the pressure-sensitive adhesive exhibit chemical affinity for each other.

27. The aircraft of claim 26, wherein the polymer film, the pattern layer, and the pressure-sensitive adhesive have values of surface tension that are within around +/−5 dyn/cm of each other.
